(19) United States
(12) Patent Application Publication
(10) Pub. No.: US 2016/0319928 A1
(43) Pub. Date: Nov. 3, 2016

(54) PIN SEAT WITH SLIP

(71) Applicants: ZF FRIEDRICHSHAFEN AG, Friedrichshafen (DE); ZF WIND POWER ANTWERPEN N.V., Lommel (BE)

(72) Inventor: Erwin VAN EYNDHOVEN, Aartselaar (BE)

(73) Assignee: ZF Friedrichshafen AG, Friedrichshafen (DE)

(21) Appl. No.: 15/110,791

(22) PCT Filed: Dec. 15, 2014
(86) PCT No.: PCT/EP2014/077712

§ 371 Date: Jul. 11, 2016

(30) Foreign Application Priority Data
Jan. 17, 2014 (DE) 10 2014 200 808.5

(51) Int. Cl. F16H 57/08

(52) U.S. Cl. CPC F16H 57/082

(57) ABSTRACT

An assembly with a planetary carrier (101) and at least a planet pin (107). The planetary carrier (101) has at least a first pin seat and (103) and a second pin seat, and the planet pin (107) can be fixed in the first pin seat (103) by way of a first interference fit and can be fixed in the second pin seat (105) by way of a second interference fit. The first interference fit has more load capacity, in the axial direction, than the second interference fit. If the length of the planet pin (107) changes due to a temperature change for example, then the second interference fit compensates for this. This allows tension of the planet pin (107) against the pin seats (103, 105) to be avoided.

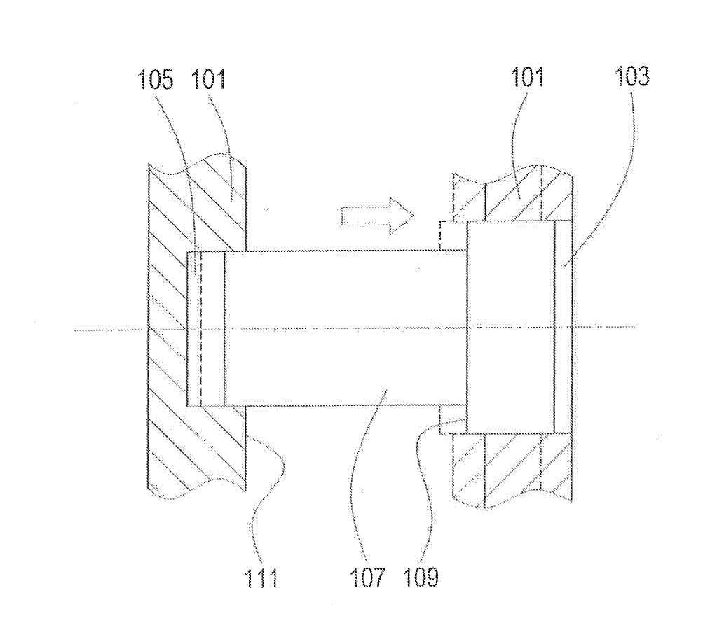

This application is a National Stage completion of PCT/EP2014/077712 filed Dec. 15, 2014, which claims priority from German patent application serial no. 10 2014 200 808.5 filed Jan. 17, 2014.

### FIELD OF THE INVENTION

The invention concerns an assembly or configuration, respectively, with a planetary carrier and at least a planet pin. Such assemblies are used in particular in transmissions of wind power installations.

### BACKGROUND OF THE INVENTION

The planetary carrier and the planet pin are provided as part of a planetary stage, which has in addition a ring gear, a sun gear, at least a planetary bearing, and at least a planetary gear wheel. The planet pin serves to accommodate the planetary bearings. Through them, the planetary wheel is rotatably supported in the planetary pin. The planetary gear meshes with the ring gear and the sun gear, which is fixed to an output shaft in a rotationally fixed manner. In general, the planetary carrier is connected in a rotationally fixed manner with a rotor in wind power installations, while the output shaft drives a generator.

The planet pin is usually fixed by two pin seats in the planetary carrier. However, during operation of the wind power installation, the planet pin can get warm. This causes expansion in the radial direction so that outward forces take effect at the pin seats. Thus, the planet pin is strained against the pin seats. This reduces the load bearing capacity of the pin seats in regard to additional, similar forces created by the planetary carrier, in the axial direction.

### SUMMARY OF THE INVENTION

The object of the invention is to improve the load bearing capacity, in particular the load bearing capacity of the planetary stage for the transmission of a wind power installation, by avoiding the inherent disadvantages of the solutions which are known in the state-of-the-art.

This task is solved through an assembly and a method as described below.

An assembly, in accordance with the invention, comprises a planetary carrier and at least one planet pin. The planetary carrier has at least a first pin seat and a second pin seat. A pin seat denotes a means to fix the planet pin in the planetary carrier.

The planet pin can be fixed in the first pin seat by means of a first interference fit and in the second pin seat with a second interference fit.

The interference fit or press fit, respectively, is usually created if the planetary carrier is initially heated up. The non-heated planet pin is inserted into the first pin seat and the second pin seat of the planetary carrier. Once the planetary carrier later cools down, the planetary carrier shrinks on to the planet pin, so that an interference fit is created in the first pin seat and a second interference fit in the second pin seat.

The planet pin serves in general to fix the planetary bearing in a first, axial direction. For this purpose, the planet pin usually has the basic shape of three rotational cylinders or straight circle cylinders, respectively, where the dimensions are different. In particular, the diameters of the two rotational cylinders are different. Consequently, at the transition between the two rotational cylinders for the planet pin, a radial extending shoulder if formed. One of the planetary bearings is positioned directly or through a spacer part—at the shoulder and is therefore fixed in reference to movement in the first axial direction.

The planetary carrier is usually designed to fix the planetary bearings in a second, axial direction. Accordingly, an additional planetary bearing—directly or through a spacer part—is positioned at a surface of a side part of the planetary carrier, opposite to the shoulder. The surface is radially oriented. This results in a fixation against movement in the second direction.

The invention is based on the understanding that the planet pin fixes the planetary bearings only in the first direction. However, the planetary bearings are fixed through the planetary carrier in the second direction, Thus, just a single interference fit is sufficient to fix the planetary bearings axially. The second interference fit is only required to fix the planet pin radially.

In accordance with the invention, the first interference fit in the axial direction is more durable than the second interference fit, that is to say the first interference fit is resilient to movement of the planet pin in the axial direction than the second interference fit, It also means that the first interference fit in the axial direction can transfer a larger maximum force than the second interference fit. The force which the first interference fit can maximally transfer in the axial direction between the planetary carrier and the planet pin is therefore larger than the force which the second interference fit can maximally transfer between the planetary carrier and the planet pin.

Thus, the second interference fit is weaker in reference to the first interference fit in the axial direction. If the length of the planet pin changes due to changes of the temperature, the weaker interference fit will compensate it. This prevents—as mentioned above—tension of the planet pin in reference to the pin seats.

In this context, the related dimensions are just based on values. A first force is therefore considered as larger if its value is larger than the value of a second force.

The axial direction is considered as being parallel to the symmetrical axis of the planet pin, or rather, to the rotational axis of the planetary bearings, or rather, to the rotation axis of a planetary gear which is rotatably supported by means of the planetary bearing on the planet pin. The symmetric axis of the planet pin is considered as an axis, around which the planet pins are rotationally symmetric.

As described above, the planet pin is usually created through two rotational cylinders and their dimensions, in particular their diameters, are different. The part of the planet pin formed with the larger diameter can be fixed in the first pin seat in the larger part of the rotational cylinder. Accordingly, the second pin seat serves to fix the part of the planet pin which is created through the rotation cylinder with the lesser diameter. Preferably, the first pin seat is the pin seat at the generator side and the second pin seat is at the rotor side of the planetary carrier.

For the installation of the planet pin in the planetary carrier, the planet pin is at least partially guided to the first pin seat. A section of the planet pin is therefore received in the second planet seat. The fixing takes finally place, as described above, through the shrinking of the planetary carrier onto the planet pin.

In a preferred embodiment, compensating for the changes of length of the planet pin is accomplished through shifting the planet pin in the second pin seat. A force which is created through a planetary bearing in the axial direction towards the planetary carrier and/or the planet pin, can therefore cause axial shifting of the planet pin in, or relative to the second pin seat, and therefore also relative to the planetary carrier,

The first pin seat serves primarily for axially fixing the planet pin. Accordingly and in a preferred additional embodiment, a force, which is present due to the force at the planetary bearing in the axial direction towards the planetary carrier and/or the planet pin in the first interference fit, is less than a force which is transferred from the first interference fit in the axial direction. The force which is present in the first interference fit is a force which is transferred through the first pin seat, or the first interference fit of the planet pin, respectively, towards the planetary carrier or by the planetary carrier to the planet pin. Accordingly, the maximum force which is transferred by the first interference fit in the axial direction is a force which can be transferred at a maximum through the first pin seat, or the first interference fit, respectively, towards the planet pin. This force is equal to the force which can be transferred in the reverse direction, meaning from the planetary carrier through the first pin seat, or the first interference fit, respectively, towards the planet pin.

In an additional preferred embodiment, shifting of the planet pin in the second pin seat is reversible. While the force which is created by the planetary bearing in the axial direction towards the planetary carrier and/or the planet pin can cause axial shifting of the planet pin in the first direction, this shifting of the planet pin happens in, or relative to the second pin seat, respectively, and therefore relative to the planetary carrier in the second direction, in accordance with the invention, through a force which can be present due to a deformation of the planetary carrier at the first interference fit.

The acting force, caused by the deformation of the planetary carrier, which is present at the first interference fit is therefore larger than the maximum force which can be transferred through the second interference fit in the axial direction between the planetary carrier and the planet pin.

The deformation of the planetary carrier is caused by the previous shifting of the planet pin in the first direction. This shifting causes the first pin seat and the second pin seat to move away from each other in the axial direction. The deformation of the planetary carrier is meant to be an elastic deformation.

To ensure a stable position of the planet pin in the planetary carrier after the shifting in the first direction and the following shifting in the second direction, the shifting can only take place in the second pin seat. However, the first interference fit shah not allow shifting of the planet pin in the first pin seat. Therefore, a force in the axial direction is preferred which can be present due to the deformation of the planetary carrier in the first interference fit, which is less than a maximum force transferred through the first interference fit in the axial direction.

The oversize of the first interference fit and the second interference fit influence their load capacity. During a manufacturing process subject to tolerances, the tolerances need to be selected in a way that the actual dimensions of the manufactured planetary carrier and the planet pin result in the corresponding oversize. In an inventive method, the tolerances for the first interference fit and the second interference fit are selected so that a lower oversize of the first interference fit is larger than the upper oversize of the second interference fit.

Additional embodiments of the method can provide a difference between the lower oversize of the first interference fit and the upper oversize of the second interference fit in a way that the manufactured planetary carriers and planet pins, in accordance with the embodiments, have the characteristics of the above described embodiments of the inventive assembly.

### BRIEF DESCRIPTION OF THE DRAWINGS

An embodiment of the invention is presented in the sole figure. Hereby, the same reference characters mark the same or functionally same characteristics. The sole figure shows the shifting of a planet pin in a planetary carrier.

### DETAILED DESCRIPTION OF THE PREFERRED EMBODIMENTS

A planetary carrier 101 which is presented in the figure has a first pin seat 103 and a second pin seat 105. A planet pin 107 is fixed in the first pin seat 103 and between the second pin seat 105.

The planet pin 107 has a shoulder 109 for an axially fixing of planetary bearings in a first direction. For the axial fixing of the planetary carrier in a second direction, opposite to the first direction, is a surface 111 of the planetary carrier 101.

A force, present in the first direction, is transferred through the shoulder 109 to the planet pin 107. In return, the planet pin 107 transfers this force through the first pin seat 103 to the planetary carrier 101. Therefore a shift occurs of the planet pin 107 in the first direction, together with a side part of the planetary carrier 101, in which the first planet seat 103 is present.

The figure presents the planet pin 107 and the planetary carrier 101 in the shifted condition. The original position of the planet pin 107 and the planetary carrier 101 is marked by a dotted line,

The second pin seat 105 is designed in a way that an interference fit between the second pin seat 105 and the planet pin 107 has only little load capacity in the axial direction. That causes that the planet pin 107 in the second pin seat 105 shifts, relative to the second pin seat 105, respectively. The planet pin 107 withdraws therefore partially from the second pin seat 105. The second pin seat 105 serves hereby to fix the planet pin 107 and the radial direction, but not in the axial direction.

Due to the shifting of the planet pin 107, the first pin seat 103 and the second pin seat 105 are moving apart, and therefore both of the side parts of the planetary carrier 101. The planetary carrier 101 is therefore extended by the shifting planet pin 107, This deformation is elastic. Therefore, the planetary carrier 101 creates a force towards the planet pin 107 which presses the planet pin 107 back in the second pin seat 105. The planet pin 107 returns therefore to the original position when the force is no longer present which was created by the planetary bearings through the shoulder 109 to words the planet pin 107 in the axial direction.

### REFERENCE CHARACTERS

101 Planetary Carrier

103 Pin Seat

105 Pin Seat

107 Planet Pin

109 Shoulder

111 Surface Area

1-6. (canceled)

7. An assembly having a planetary carrier (10 1) and at least a planet pin (107);
wherein the planetary carrier (10 1) has at least a first pin seat (103) and a second pin seat (105);
the planet pin (107) is fixed in the first pin seat (103) by a first interference fit and the planet pin (107) is fixed in the second pin seat (105) by a second interference fit; and
the first interference fit has a greater load capacity, in an axial direction, than the second interference fit.

8. The assembly according to claim 7, further comprising a force created by a planetary bearing, in the axial direction towards at least one of the planetary carrier (101) and the planet pin (107), causes shifting of the planet pin (107) in the second pin seat (105).

9. The assembly according to claim 7, further comprising that a force, which is created by a planetary bearing in the axial direction towards at least one of the planetary carrier (101) and the planet pin (107), and which is present in the first interference fit, is less than a maximum transferred force of the first interference fit in the axial direction.

10. The assembly according to claim 8, further comprising that the force which can take effect at the first interference fit, due to deformation of the planetary carrier (101), causes shifting of the planet pin (107) in the second pin seat (105).

11. The assembly according to claim 10, further comprising that the force in the axial direction, which can take effect due to the deformation of the planetary carrier (101) in the first interference fit, is less than a maximum transferred force of the first interference fit in the axial direction.

12. A method of constructing an assembly having a planetary carrier (101) and at least a planet pin (107), the planetary carrier (101) has at least a first pin seat (103) and a second pin seat (105), and the planet pin (107) is fixed in the first pin seat (103) by a first interference fit, and the planet pin (107) is fixed in the second pin seat (105) by a second interference fit, the first interference fit has a greater load capacity in an axial direction than the second interference fit, the method comprising:
forming the first interference fit and the second interference fit to have tolerances so that a lower oversize of the first interference fit is larger than an upper oversize of the second interference fit.
